(19) United States
(12) Patent Application Publication
(10) Pub. No.: US 2026/0065521 A1
(43) Pub. Date: Mar. 5, 2026

(54) DOMAIN-SPECIFIC ATTRIBUTE-ADAPTER AUGMENTING PRE-TRAINED TEXT-TO-IMAGE DIFFUSION MODELS

(71) Applicant: TOYOTA RESEARCH INSTITUTE, INC., Los Altos, CA (US)

(72) Inventors: Wonwoong CHO, West Lafayette, IN (US); Yanxia ZHANG, Foster City, CA (US); Yin-Ying CHEN, San Jose, CA (US); Matthew Evans KLENK, San Francisco, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/984,685

(22) Filed: Dec. 17, 2024

Related U.S. Application Data
(60) Provisional application No. 63/689,238, filed on Aug. 30, 2024.

(51) Int. Cl. G06T 11/00; G06N 5/04; G06N 20/00

(52) U.S. Cl. CPC G06T 11/00; G06N 5/04; G06N 20/00

(57) ABSTRACT

A method for a domain-specific attribute-adapter is described. The method includes learning domain-specific attributes from a collection of domain-specific images. The method also includes encoding a latent space of a pre-trained text-to-image diffusion model according to the learned domain-specific attributes from the collection of domain-specific images. The method further includes decoding the latent space in response to a received text prompt and one or more conditions. The method also includes inferring a series of images based on decoding the latent space in response to the received text prompt and the one or more conditions.

### CROSS-REFERENCE TO RELATED APPLICATION

The present application claims the benefit of U.S. Provisional Patent Application No. 63/689,238, filed Aug. 30, 2024, and titled “TEXT CANNOT DESCRIBE EVERYTHING IN IMAGE: DOMAIN-SPECIFIC ATTRIBUTE (ATT) ADAPTER AUGMENTING PRETRAINED T21 DIFFUSION MODELS,” the disclosure of which is expressly incorporated by reference herein in its entirety.

### BACKGROUND

### Field

Certain aspects of the present disclosure generally relate to machine assisted design and, more particularly, to a system and method for a domain-specific attribute-adapter augmenting pre-trained text-to-image diffusion models.

### Background

An artificial neural network, which may include an interconnected group of artificial neurons, may be a computational device or may represent a method to be performed by a computational device. Artificial neural networks may have corresponding structure and/or function in biological neural networks. Artificial neural networks, however, may provide useful computational techniques for certain applications, in which traditional computational techniques may be cumbersome, impractical, or inadequate. Because artificial neural networks may infer a function from observations, such networks may be useful in applications where the complexity of the task and/or data makes the design of the function burdensome using conventional techniques.

Recently, text-to-image (T2I) diffusion models provide an improved image creation tool. Diffusion models are a successful class of generative artificial intelligence (AI) models that exhibit remarkable performance in diverse tasks. For example, diffusion models can generate images that model the diverse nature of the visual world. Additionally, diffusion models are intuitively controlled using text guidance and support plug-in conditioning based on diverse modalities. Unfortunately, creating sufficient text prompts for intuitively controlling the diffusion models is problematic because image design language is different from common language. A domain-specific attribute-adapter for augmenting pre-trained T2I diffusion models, is desired.

### SUMMARY

A method for a domain-specific attribute-adapter is described. The method includes learning domain-specific attributes from a collection of domain-specific images. The method also includes encoding a latent space of a pre-trained text-to-image diffusion model according to the learned domain-specific attributes from the collection of domain-specific images. The method further includes decoding the latent space in response to a received text prompt and one or more conditions. The method also includes inferring a series of images based on decoding the latent space in response to the received text prompt and the one or more conditions.

A non-transitory computer-readable medium having program code recorded thereon for a domain-specific attribute-adapter is described. The program code is executed by a processor. The non-transitory computer-readable medium includes program code to learn domain-specific attributes from a collection of domain-specific images. The non-transitory computer-readable medium also includes program code to encode a latent space of a pre-trained text-to-image diffusion model according to the learned domain-specific attributes from the collection of domain-specific images. The non-transitory computer-readable medium further includes program code to decode the latent space in response to a received text prompt and one or more conditions. The non-transitory computer-readable medium also includes program code to infer a series of images based on decoding the latent space in response to the received text prompt and the one or more conditions.

A system for a domain-specific attribute-adapter is described. The system includes a domain-specific attributes learning model to learn domain-specific attributes from a collection of domain-specific images. The system also includes a latent space encoding model to encode a latent space of a pre-trained text-to-image diffusion model according to the learned domain-specific attributes from the collection of domain-specific images. The system further includes a conditional latent space decoding model to decode the latent space in response to a received text prompt and one or more conditions. The system also includes an image generation model infer a series of images based on decoding the latent space in response to the received text prompt and the one or more conditions.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of an attribute-adapter of pre-trained text-to-image (T2I) diffusion models using a system-on-a-chip (SOC), in accordance with various aspects of the present disclosure.

FIG. 2 is a block diagram illustrating an exemplary software architecture that may modularize artificial intelligence (AI) functions for an attribute-adapter of pre-trained text-to-image (T2I) diffusion models, according to various aspects of the present disclosure.

FIG. 3 is a block diagram illustrating a hardware implementation for an attribute-adapter of a text-to-image (T2I) generation system, according to various aspects of the present disclosure.

FIGS. 4A and 4B are block diagrams illustrating an attribute-adapter for a text-to-image (T2I) generation system, according to various aspects of the present disclosure.

FIG. 5 is a block diagram further illustrating the attribute-adapter for a text-to-image (T2I) generation system of FIGS. 4A and 4B, according to various aspects of the present disclosure.

FIG. 6 is a block diagram illustrating the attribute-adapter for a text-to-image (T2I) generation system of FIGS. 4A and 4B, according to various aspects of the present disclosure.

FIGS. 7A and 7B are block diagrams illustrating the attribute-adapter for a text-to-image (T2I) generation system of FIG. 5 during inference, according to various aspects of the present disclosure.

FIG. 8 is a process flow diagram illustrating a method for a domain-specific attribute-adapter, according to various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

An artificial neural network, which may include an interconnected group of artificial neurons, may be a computational device or may represent a method to be performed by a computational device. Artificial neural networks may have corresponding structure and/or function in biological neural networks. Artificial neural networks, however, may provide useful computational techniques for certain applications, in which traditional computational techniques may be cumbersome, impractical, or inadequate. Because artificial neural networks may infer a function from observations, such networks may be useful in applications where the complexity of the task and/or data makes the design of the function burdensome using conventional techniques.

Image synthesis is a field of computer vision experiencing significant recent developments. Despite these recent significant developments, image synthesis involves substantial computational demands when performing high-resolution synthesis of complex, natural scenes. Recently, diffusion models have achieved impressive results in image synthesis. Diffusion models are probabilistic models designed to learn a data distribution by gradually denoising a normally distributed variable, which corresponds to learning the reverse process of a fixed Markov Chain.

In particular, diffusion models are a successful class of generative artificial intelligence (AI) models that exhibit remarkable performance in diverse tasks. For example, diffusion models can generate images that model the diverse nature of the visual world. Additionally, diffusion models are intuitively controlled using text guidance and support plug-in conditioning based on diverse modalities. Unfortunately, creating sufficient text prompts for intuitively controlling the diffusion models is problematic because image design language is different from common language.

In practice, diffusion models exhibit limited detailed attribute control over a specific domain. This limited attribute control is generally due to a lack of specialization between a target domain and pre-trained knowledge of the diffusion models. Solving this problem involves finetuning/training the domain specification attributes of the diffusion models. Additionally, the text-based guide of diffusion models is limited to representing continuous values in fundamental values and/or scalable values (e.g., multiple conditionings).

Another issue with diffusion models is that pre-trained knowledge of diffusion models is not well harmonized with the domain-specific attribute control. This lack of harmony arises because both the domain-specific attributes and a text prompt for using the pre-trained knowledge are supplied together as text. As a result, naively adding domain-specific attributes to text may not provide a solution to this limitation. A domain-specific attribute-adapter for augmenting pre-trained text-to-image (T2I) diffusion models, is desired.

Various aspects to the present disclosure are directed to a domain-specific attribute-adapter for pre-trained diffusion models. In some implementations, the domain-specific attribute-adapter includes the following capabilities: (1) an ability to learn and control the domain-specific attributes of pre-trained diffusion models; (2) an ability to accept a continuous value as a condition; (3) an ability to provide scalability for multiple conditions; and/or (4) an ability to harmonize well with the pre-trained diffusion models.

Various aspects of the present disclosure combine conditional variational autoencoders with image prompt (IP) adapter models to form a domain-specific attribute (Att)-adapter for augmenting pre-trained text-to-image (T2I) diffusions models. The Att-adapter provides improved control over domain-specific attributes in generating images. The Att-adapter is first trained using domain-specific data. Next the Att-adapter is applied to pre-trained diffusion models, in which control over the domain-specific attributes is supported, including, but not limited to, pose (e.g., angle or point-of-view (POV)), or the size of an in-domain object.

In some implementations, an Att-adapter for pre-trained diffusion models aims to learn and control domain-specific attributes. Additionally, an Att-adapter model allows for the generation of images without specifying an input image, which improves control over continuous attributes. The training process involves the use of a pre-trained model and a newly introduced variational autoencoder (VAE) module. Additionally, multiple images are used to train a diffusion model and learn domain-specific attribute distributions. The Att-adapter overcomes issues associated with text prompts for image descriptions, which are challenging due to domain-specific terminology and nuances in visual content. Additionally, the Att-adapter overcomes issues of existing methods for text-to-image models, which provide limited control of detailed attributes and do not harmonize with pre-trained knowledge.

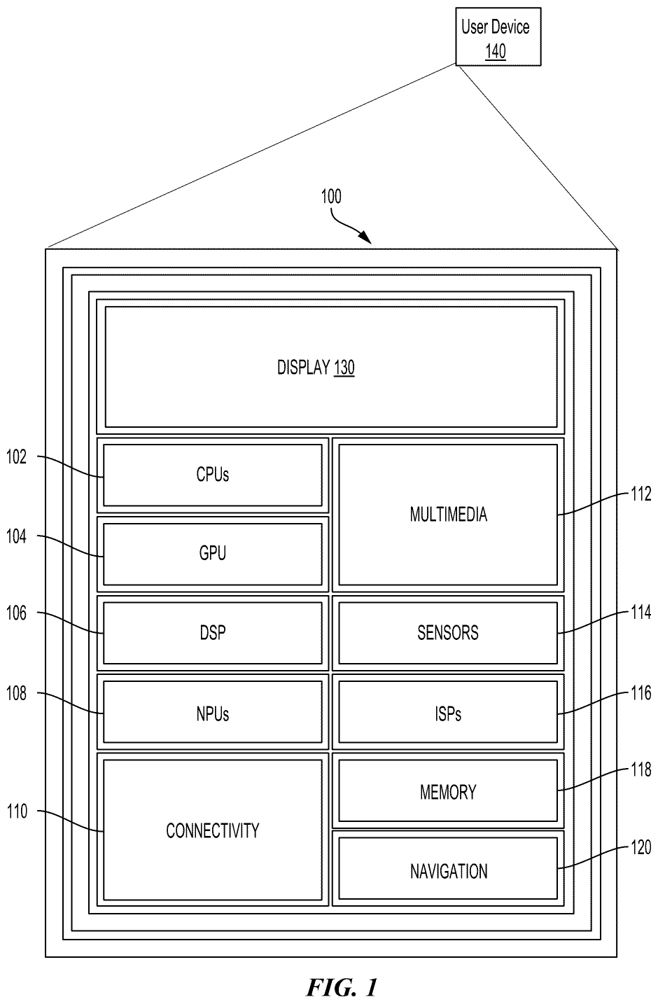

FIG. 1 illustrates an example implementation of the aforementioned system and method for an attribute-adapter of pre-trained text-to-image (T2I) diffusion models using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., the CPU 102) or the NPU 108 may include code to provide an attribute-adapter of pre-trained text-to-image (T2I) diffusion models. The instructions loaded into a processor (e.g., the NPU 108) may also include code to learn domain-specific attributes from a collection of domain-specific images. The instructions loaded into the processor (e.g., the NPU 108) may also include code to encode a latent space of a pre-trained text-to-image diffusion model according to the learned domain-specific attributes from the collection of domain-specific images. The instructions loaded into the processor (e.g., the NPU 108) may also include code to decode the latent space in response to a received text prompt and one or more conditions. The instructions loaded into the processor (e.g., the NPU 108) may also include code to infer a series of images based on decoding the latent space in response to the received text prompt and the one or more conditions.

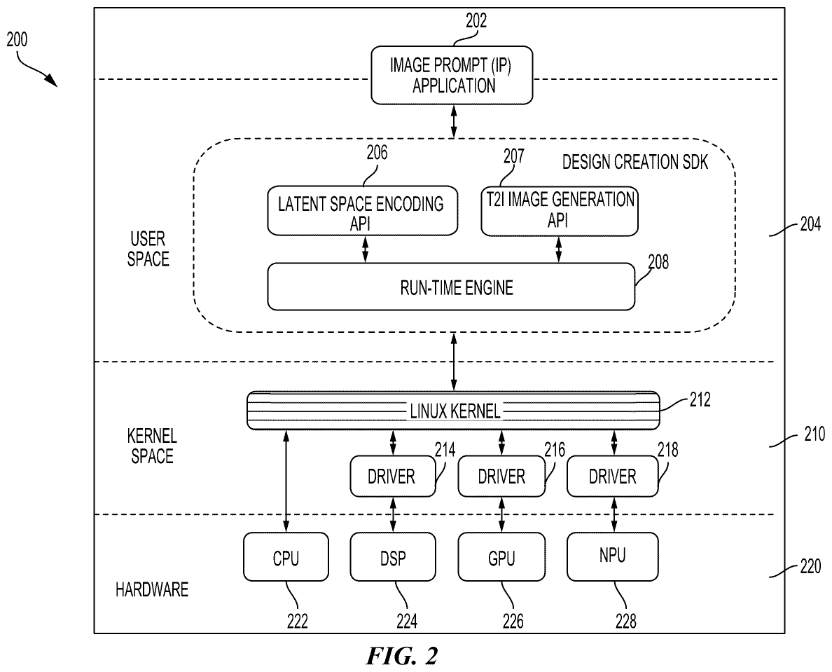

FIG. 2 is a block diagram illustrating a software architecture 200 that may modularize artificial intelligence (AI) functions for an attribute-adapter of pre-trained text-to-image (T2I) diffusion models, according to aspects of the present disclosure. Using the software architecture 200, an image prompt (IP) application 202 may be designed such that it may cause various processing blocks of a system-on-a-chip (SOC) 220 (for example a CPU 222, a DSP 224, a GPU 226, and/or an NPU 228) to perform supporting computations during run-time operation of the IP application 202. FIG. 2 describes the software architecture 200 for a visual content design system. It should be recognized that the visual content design system is not limited to any specific information. According to aspects of the present disclosure, the user monitoring and the visual content design functionality is applicable to any type of creativity support tool (CST).

The IP application 202 may be configured to call functions defined in an image space 204 that may, for example, provide visual content design services. The IP application 202 may make a request for compiled program code associated with a library defined in a latent space encoding application programming interface (API) 206. The latent space encoding API 206 is configured to encode a latent space of a pre-trained T2I diffusion model according to learned domain-specific attributes from a collection of domain-specific images.

In response, compiled program code of a T2I image generation API 207 is configured to decode the latent space in response to a received text prompt and one or more conditions. Additionally, the T2I image generation API 207 is configured to infer a series of images based on decoding the latent space in response to the received text prompt and the one or more conditions.

A run-time engine 208, which may be compiled code of a run-time framework, may be further accessible to the IP application 202. The IP application 202 may cause the run-time engine 208, for example, to embedded domain-specific attributes in pre-trained T2I diffusion models for improving the design of visual content. In response to embedded domain-specific attributes, the run-time engine 208 may in turn send a signal to an operating system 210, such as a Linux Kernel 212, running on the SOC 220. FIG. 2 illustrates the Linux Kernel 212 as software architecture for a visual content creation system. It should be recognized, however, that aspects of the present disclosure are not limited to this exemplary software architecture. For example, other kernels may provide the software architecture to support the visual content design functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

As noted, diffusion models are a successful class of generative artificial intelligence (AI) models that exhibit remarkable performance in diverse tasks. For example, diffusion models can generate images that model the diverse nature of the visual world. Additionally, diffusion models are intuitively controlled using text guidance and support plug-in conditioning based on diverse modalities. Unfortunately, creating sufficient text prompts for intuitively controlling the diffusion models is problematic because image design language is different from common language.

In practice, diffusion models exhibit limited detailed attribute control over a specific domain. This limited attribute control is generally due to a lack of specialization between a target domain and pre-trained knowledge of the diffusion models. Solving this problem involves finetuning/training the domain specification attributes of the diffusion models. Additionally, the text-based guide of diffusion models is limited to representing continuous values in fundamental values and/or scalable values (e.g., multiple conditionings).

Another issue with diffusion models is that pre-trained knowledge of diffusion models is not well harmonized with the domain-specific attribute control. This lack of harmony arises because both the domain-specific attributes and a text prompt for using the pre-trained knowledge are supplied together as text. As a result, naively adding domain-specific attributes to text may not provide a solution to this limitation. A domain-specific attribute-adapter for augmenting pre-trained text-to-image (T2I) diffusion models, is desired.

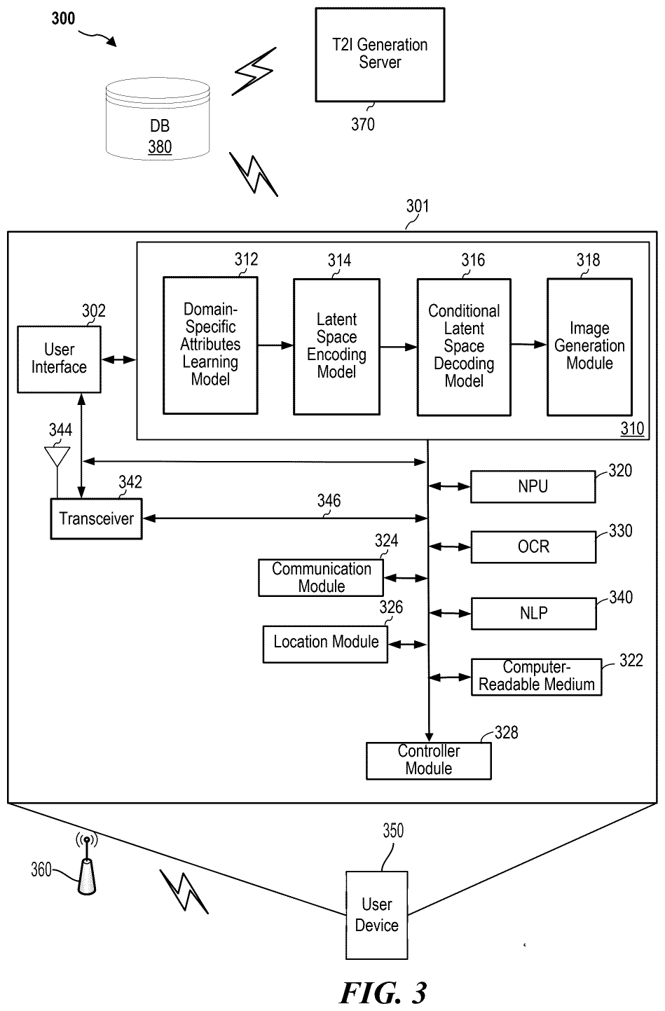

Various aspects of the present disclosure combine conditional variational autoencoders with image prompt (IP) adapter models to form a domain-specific attribute (Att)-adapter for augmenting pre-trained text-to-image (T2I) diffusions models. The Att-adapter provides improved control over domain-specific attributes in generating images. The Att-adapter is first trained using domain-specific data. Next the Att-adapter is applied to pre-trained diffusion models, in which control over the domain-specific attributes is supported, including, but not limited to, pose (e.g., angle or point-of-view (POV), or the size of an in-domain object, for example, as shown in FIG. 3.

FIG. 3 is a block diagram illustrating a hardware implementation for an attribute-adapter of a text-to-image (T2I) generation system 300, according to aspects of the present disclosure. The T2I generation system 300 provides (1) an ability to learn and control the domain-specific attributes of pre-trained diffusion models; (2) an ability to accept a continuous value as a condition; (3) an ability to provide scalability for multiple conditions; and/or (4) an ability to harmonize well with the pre-trained diffusion models. The T2I generation system 300 combines conditional variational autoencoders with image prompt (IP) adapter models to form a domain-specific attribute (Att)-adapter for augmenting pre-trained T2I diffusion models. The T2I generation system 300 provides improved control over domain-specific attributes in generating images. The T2I generation system 300 is first trained using domain-specific data. Next the Att-adapter is applied to pre-trained diffusion models, in which control over the domain-specific attributes is supported, including, but not limited to, pose (e.g., angle or point-of-view (POV)), or the size of an in-domain object.

The T2I generation system 300 includes a domain-specific image generation system 301 and a T2I generation server 370 in this aspect of the present disclosure. The domain-specific image generation system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The T2I generation server 370 may connect to the user device 350 to provide an attribute-adapter of pre-trained text-to-image (T2I) diffusion models. The T2I generation server 370 is configured to learn domain-specific attributes from a collection of domain-specific images. Additionally, the T2I generation server 370 is configured to encode a latent space of a pre-trained T2I diffusion model according to the learned domain-specific attributes from the collection of domain-specific images. The T2I generation server 370 is further configured to decode the latent space in response to a received text prompt and one or more conditions. The T2I generation server 370 may also infer a series of images based on decoding the latent space in response to the received text prompt and the one or more conditions, which are presented on the user device 350.

The domain-specific image generation system 301 may be implemented with an interconnected architecture, represented by an interconnect 346, which may be implemented as a controller area network (CAN). The interconnect 346 may include any number of point-to-point interconnects, buses, and/or bridges depending on the specific application of the domain-specific image generation system 301 and the overall design constraints. The interconnect 346 links together various circuits including one or more processors and/or hardware modules, represented by a user interface 302, a domain-specific image generation module 310, a neural network processor (NPU) 320, a computer-readable medium 322, a communication module 324, a location module 326, a controller module 328, an optical character recognition (OCR) 330, and a natural language processor (NLP) 340. The interconnect 346 may also link various other circuits such as timing sources, peripherals, voltage regulators, and power management circuits, which are well known in the art, and therefore, will not be described any further.

The domain-specific image generation system 301 includes a transceiver 342 coupled to the user interface 302, the domain-specific image generation module 310, the NPU 320, the computer-readable medium 322, the communication module 324, the location module 326, the controller module 328, the OCR 330, and NLP 340. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the domain-specific image generation module 310 to/from connected devices within the vicinity of the user device 350.

The domain-specific image generation system 301 includes the NPU 320, the OCR 330, and the NLP 340 coupled to the computer-readable medium 322. The NPU 320, the OCR 330, and NLP 340 performs processing, including the execution of software stored on the computer-readable medium 322 to provide a neural network model for augmenting pre-trained text-to-image (T2I) diffusion models, according to various aspects of the present disclosure. The software, when executed by the NPU 320, the OCR 330 and the NLP 340, causes the domain-specific image generation system 301 to perform the various functions described for presenting conditional, domain-specific images to the user through the user device 350, or any of the modules (e.g., 310, 324, 326, and/or 328). The computer-readable medium 322 may also be used for storing data that is manipulated by the OCR 330 and the NLP 340 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the user device 350 and/or the location module 326 compliant with the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the domain-specific image generation system 301. The transceiver 342 may be a communications channel through a network access point 360. The communications channel may include DSRC, LTE, LTE-D2D, mm Wave, Wi-Fi (infrastructure mode), Wi-Fi (ad-hoc mode), visible light communication, TV white space communication, satellite communication, full-duplex wireless communications, or any other wireless communications protocol such as those mentioned herein.

The domain-specific image generation module 310 may be in communication with the user interface 302, the NPU 320, the computer-readable medium 322, the communication module 324, the location module 326, the controller module 328, the OCR 330, the NLP 340, and the transceiver 342. In one configuration, the domain-specific image generation module 310 monitors communications from the user interface 302. The user interface 302 may monitor user communications to and from the communication module 324. According to aspects of the present disclosure, the OCR 330 and the NLP 340 automatically detect a series of images displayed on the user's workspace and may use computer vision object detection and instance segmentation techniques to automatically detect the objects in the image to learn domain-specific details regarding the series of images.

As shown in FIG. 3, the domain-specific image generation module 310 includes a domain-specific attributes learning model 312, a latent space encoding model 314, a conditional latent space decoding model 316, and an image generation module 318. The domain-specific attributes learning model 312, the latent space encoding model 314, the conditional latent space decoding model 316, and the image generation module 318 may be components of a same or different artificial neural network, such as a deep convolutional neural network (CNN). The domain-specific image generation module 310 is not limited to a CNN. The domain-specific image generation module 310 is configured to provide an attribute-adapter of pre-trained text-to-image (T2I) diffusion models.

This configuration of the domain-specific image generation module 310 includes the domain-specific attributes learning model 312 configured to learn domain-specific attributes from a collection of domain-specific images. In various aspects of the present disclosure, the domain-specific attributes learning model 312 is implemented to allow user specification of the collection of the domain-specific images from which the domain-specific attributes are learned. Once the domain-specific attributes learning model 312 learns domain-specific attributes data, the domain-specific attributes data is used to train a pre-trained T2I diffusion model. In this example, multiple images are used to train a T2I diffusion model and learn domain-specific attribute distributions. For example, the T2I diffusion model may be an image prompt (IP) diffusion model. Alternatively, users could directly provide the collection of the domain-specific images to a dedicated web user interface, such as the T2I generation server 370.

In various aspects of the present disclosure, the domain-specific image generation module 310 includes the latent space encoding model 314 configured to encode a latent space of a pre-trained text-to-image diffusion model according to the learned domain-specific attributes from the collection of domain-specific images. In some implementations, the latent space encoding model 314 is configured as an encoder of a conditional, variational autoencoder (CVAE). The latent space encoding model 314 embeds the learned domain-specific attributes into a pre-trained IP diffusion model. This embedding harmonizes the pre-trained knowledge of the pre-trained IP diffusion model with the domain-specific attributes.

In this example, the domain-specific image generation module 310 also includes the conditional latent space decoding model 316 configured to decode the latent space in response to a received text prompt and one or more received conditions. In various aspects of the present disclosure, the conditional latent space decoding model 316 is implemented using a conditional variational autoencoder (CVAE). For example, the conditional latent space decoding model 316 enables inference prediction without an image prompt (IP), but with various conditional attributes, in contrast to conventional IP adapters.

As shown in FIG. 3, the domain-specific image generation module 310 further includes the image generation module 318 configured to infer a series of images based on decoding the latent space in response to the received text prompt and the one or more received conditions, which are presented on the user device 350. According to various aspects of the present disclosure, the domain-specific image generation module 310 overcomes issues associated with text prompts for image descriptions, which are challenging due to domain-specific terminology and nuances in visual content. Additionally, the domain-specific image generation module 310 overcomes issues of existing methods for text-to-image models, which provide limited control of detailed attributes and do not harmonize with the pre-trained knowledge of diffusion models.

In some aspects of the present disclosure, the domain-specific image generation module 310 may be implemented and/or work in conjunction with the T2I generation server 370. In one configuration, a database (DB) 380 enables deferring some control to the T2I generation server 370 generation of the series of images based on decoding of the latent space in response to the received image prompt and the received conditions, which may be displayed as output through the user interface 302. In some aspects of the present disclosure, the T2I generation system 300 may be implemented as a web browser plugin. In other aspects of the present disclosure, the T2I generation server 370 provides an offline application that scans content viewed through the user interface 302. In other aspects of the present disclosure, the T2I generation system 300 may be implemented as a mobile application that augments the text-to-image process for providing images through the user interface 302 without specifying an input image, which improves control over continuous attributes.

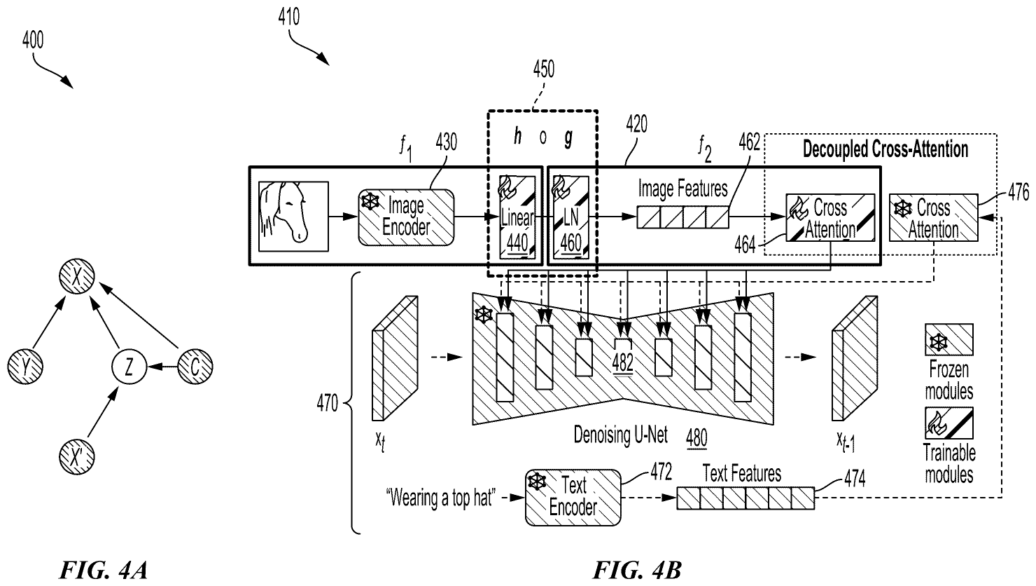

FIGS. 4A and 4B are block diagrams illustrating an attribute-adapter for a text-to-image (T2I) generation system, according to various aspects of the present disclosure. As shown in FIG. 4A, an image prompt (IP) adapted T2I generator 400 may be configured as a conditional variational IP (VIP) adapter. In this example, generated images X are generated based on input text prompt Y, an image prompt X′, and one or more conditions C. In various aspects of the present disclosure, the IP adapted T2I generator 400 performs a training process, which involves the use of a pre-trained model and a conditional variational autoencoder (CVAE) to generate a latent space Z based on a collection of domain-specific images provided from the image prompt X′. In this implementation, the latent space Z balances pre-trained knowledge of pre-trained diffusion models and domain-specific attributes to improve text-to-image generation.

FIG. 4B is an attribute-adapter for a text-to-image (T2I) generation system 410, according to various aspects of the present disclosure. As shown in FIG. 4B, domain-specific attributes are embedded in a pre-trained diffusion model by utilizing a convolutional variable autoencoder (CVAE) 450 in combination with a pre-trained IP adapter 420 of a stable diffusion architecture 470. In this example, the pre-trained IP adapter 420 includes a contrastive language-image pre-training (CLIP) encoder 430 that encodes an image, which is provided to a linear layer 440 followed by a layer-normalization (LN) layer 460. Additionally, image features from the LN layer 460 are provided to a trained cross attention block 464.

According to various aspects of the present disclosure, the CVAE 450 is introduced between the linear layer 440 and the LN layer 460 of the pre-trained IP adapter 420. In this implementation, the CVAE 450 is configured to embed domain-specific attributes in the linear layer 440 and the LN layer 460 of the pre-trained IP adapter 420. Based on the embedded domain-specific attributes, image features 462 are generated and provided to the trained cross attention block 464. Additionally, a cross-attention block 476 of stable diffusion architecture 470 is provided text features 474 generated by a text encoder 472 from a text input (e.g., “Wearing a top hat”). An output of the trained cross attention block 464 and an output of the cross-attention block 476 are provided to a denoising U-Net 480 of the stable diffusion architecture 470.

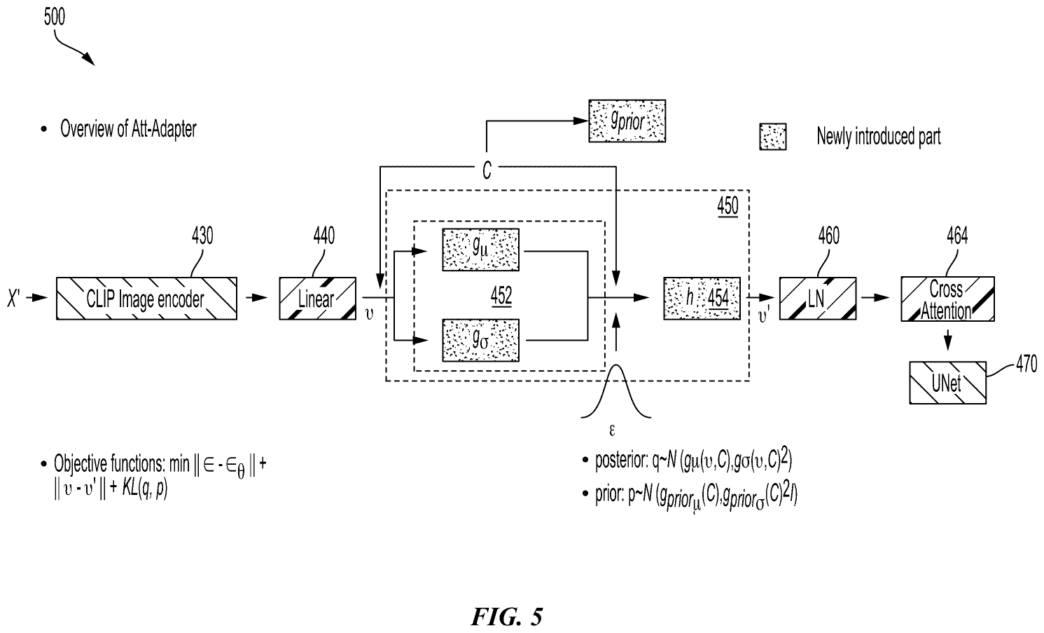

As shown in FIG. 4B, the stable diffusion architecture 470 includes the denoising U-Net 480, which receives a latent xₜ for computation of a conditional or unconditional latent space (e.g., xₜ₋₁). The denoising U-Net 480 further includes an encoder and a decoder having cross-attention blocks 482. In this example, the cross-attention blocks 482 are coupled to the trained cross attention block 464 and the cross-attention block 476 of the stable diffusion architecture 470. An output of the denoising U-Net 480 is a previous latent xₜ₋₁, which is used to infer an image, as further illustrated in FIG. 5.

FIG. 5 is a block diagram further illustrating the attribute-adapter for a text-to-image (T2I) generation system of FIGS. 4A and 4B, according to various aspects of the present disclosure. As shown in FIG. 5, the image prompt X′ is received by the CLIP encoder 430, which generates an encoded image prompt X′ that is provided to the linear layer 440. In this example, the linear layer 440 outputs a vector v, which is provided to an encoder 452. In this implementation, configuration of the CVAE 450 assumes a posterior to be multivariate gaussian that is approximate the CVAE 450 according to Equation (1):

$$posterior : q ∼ N ( {g}_{μ} ( v , C ) , {{g}_{σ} ( v , C )}^{2} ) \qquad ( 1 )$$

Additionally, a prior set also to be multivariate gaussian having a class-conditional distribution according to Equation (2):

$$prior : p ∼ N ( {g}_{prio {r}_{μ}} ( C ) , {{g}_{prio {r}_{σ}} ( C )}^{2} I ) \qquad ( 2 )$$

Regarding an object function, a standard denoising objective of diffusion models and an estimated lower bound (ELBO) of the reconstruction and Kullback Leibler (KL) divergence of the CVAE 450 are provided according to Equation (3):

$$Objective functions : min ‖ ∈ - {∈}_{θ} ‖ + ‖ v - {v}^{′} ‖ + KL ( q , p ) \qquad ( 3 )$$

As shown in FIG. 5, the CVAE 450 receives the vector v output from the linear layer 440 and one or more conditions C. The encoder 452 of the CVAE 450 includes a gaussian standard deviation g_{σ} and a gaussian mean g_{μ} to approximate the gaussian prior gₚᵣᵢₒᵣ according to Equation (2). Additionally, a decoder 454 in combination with the encoder 452 is approximate the posterior v′, according to Equation (1). Subsequently, the posterior v′ is provided to the LN layer 460, to the trained cross attention block 464 and finally to the denoising U-Net 480.

In this example, training of the CVAE 450 may be performed according to Equation (4):

$${g}_{σ} ( v , C ) ε + {g}_{μ} ( v , C ) , where ε ∼ N ( 0 , I ) \qquad ( 4 )$$

Additionally, sampling from the CVAE 450 may be performed according to Equation (5):

$${g}_{prio {r}_{σ}} ( C ) ε + {g}_{prio {r}_{μ}} ( C ) , where ε ∼ N ( 0 , I ) \qquad ( 5 )$$

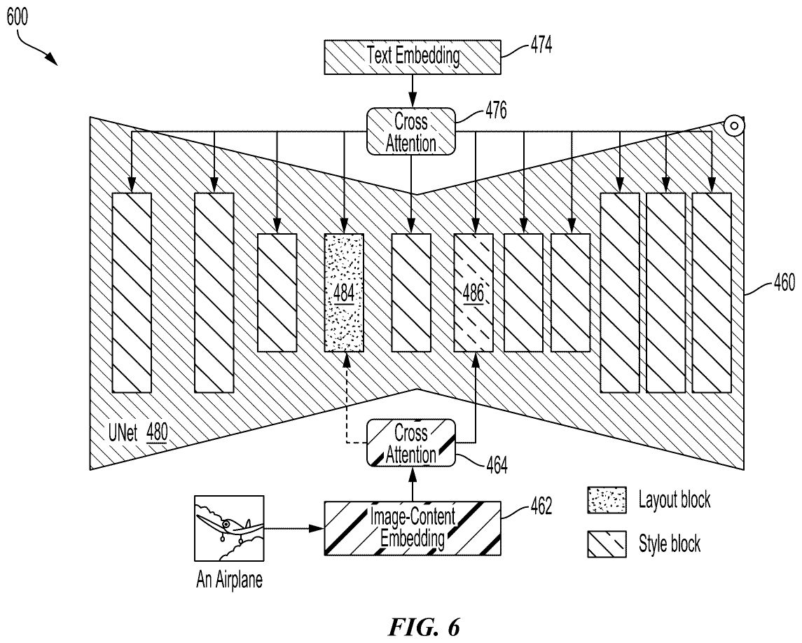

FIG. 6 is a block diagram illustrating the attribute-adapter for a text-to-image (T2I) generation system of FIGS. 4A and 4B, according to various aspects of the present disclosure. FIG. 6 further illustrates control of conditional effects of a stable diffusion architecture 600. The stable diffusion architecture 600 is similar to the stable diffusion architecture 470 of FIG. 4B and described using similar reference numbers.

As shown in FIG. 6, the image features 462 provide an image content embedding that is fed to the trained cross attention block 464, which updates a layout cross attention block 484 and a style attention block 486. Similarly, the text features 474 provide a text embedding that is fed to the cross-attention block 476, which also updates the layout cross attention block 484 and the style attention block 486. This training of the denoising U-Net 480 provides improved control over domain-specific attributes and conditional effects in generating images. As shown in FIG. 6, the training process involves separately performing image content embedding of an image prompt from a text embedding of the received text prompt in the denoising U-Net 480. Additionally, this training of the denoising U-Net 480 ensures control over the domain-specific attributes, including, but not limited to, pose (e.g., angle or point-of-view (POV)), or the size of an in-domain object.

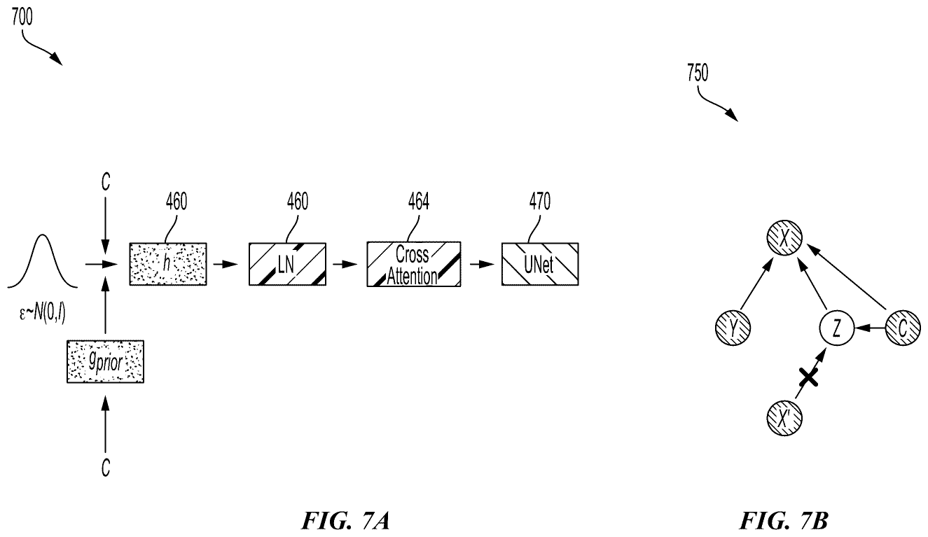

FIGS. 7A and 7B are block diagrams illustrating the attribute-adapter for a text-to-image (T2I) generation system of FIG. 5 during inference, according to various aspects of the present disclosure. As shown in FIG. 7A, an attribute-adapter for a T2I generation system 700 is similar to the attribute-adapter for the T2I generation system 410 of FIG. 4B and described using similar reference numbers.

As shown in FIG. 7A, during inference operation, the T2I generation system 700 does not utilize the CVAE 450, as shown in FIG. 5. As a result, the image prompt X′, as shown in FIG. 5, is unnecessary for performing the inference operation of the T2I generation system 700. In various aspects of the present disclosure, a conditional latent space decoding model (e.g., gₚᵣᵢₒᵣ) enables explicit modeling and providing of the domain-specific attribute conditions C using just the decoder 454 of the CVAE 450. As shown in FIG. 7B, the conditional latent space Z of an image prompt (IP) adapted text-to-image (T2I) generator 750 enables inference prediction without the image prompt X′, but with the domain-specific continuous attribute conditions C, in contrast to conventional IP adapters.

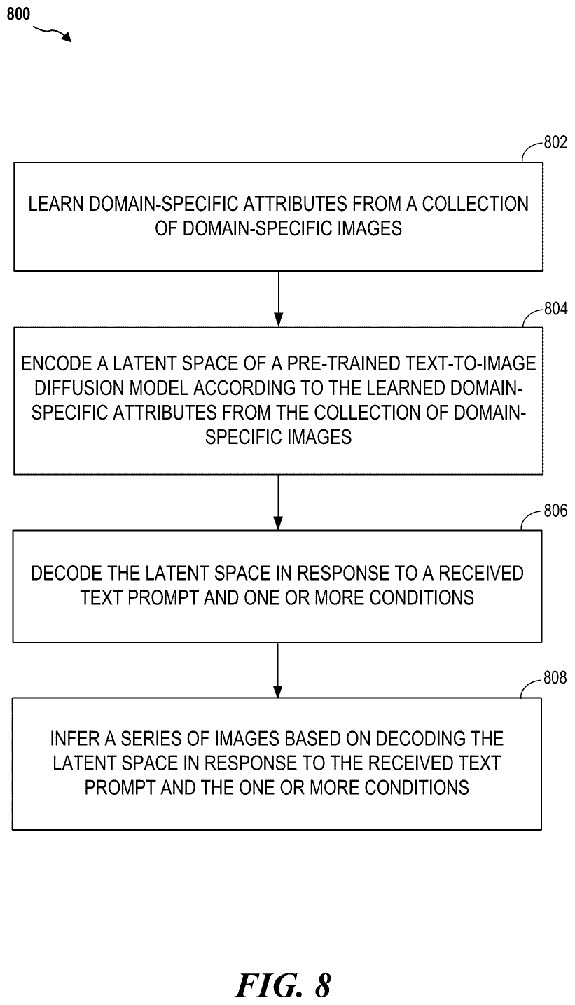

FIG. 8 is a process flow diagram illustrating a method 800 for a domain-specific attribute-adapter, according to various aspects of the present disclosure. A method 800 begins at block 802, in which domain-specific attributes are learned from a collection of domain-specific images. For example, as shown in FIG. 3, the domain-specific image generation module 310 includes the domain-specific attributes learning model 312 configured to learn domain-specific attributes from a collection of domain-specific images. In various aspects of the present disclosure, the domain-specific attributes learning model 312 is implemented to allow user specification of the collection of the domain-specific images from which the domain-specific attributes are learned. Once the domain-specific attributes learning model 312 learns domain-specific attributes data, the domain-specific attributes data is used to train a pre-trained T2I diffusion model. In this example, multiple images are used to train a T2I diffusion model and learn domain-specific attribute distributions. For example, the T2I diffusion model may be an image prompt (IP) diffusion model. Alternatively, users could directly provide the collection of the domain-specific images to a dedicated web user interface, such as the T2I generation server 370.

At block 804, a latent space of a pre-trained text-to-image diffusion model is encoded according to the learned domain-specific attributes from the collection of domain-specific images. For example, as shown in FIG. 3, the domain-specific image generation module 310 includes the latent space encoding model 314 configured to encode a latent space of a pre-trained text-to-image diffusion model according to the learned domain-specific attributes from the collection of domain-specific images. In some implementations, the latent space encoding model 314 is configured as an encoder of a conditional, variational autoencoder (CVAE). The latent space encoding model 314 embeds the learned domain-specific attributes into a pre-trained IP diffusion model. This embedding harmonizes the pre-trained knowledge of the pre-trained IP diffusion model with the domain-specific attributes.

At block 806, the latent space is decoded in response to a received text prompt and one or more conditions. For example, as shown in FIG. 3, the domain-specific image generation module 310 also includes the conditional latent space decoding model 316 configured to decode the latent space in response to a received text prompt and one or more received conditions. In various aspects of the present disclosure, the conditional latent space decoding model 316 is implemented using a conditional variational autoencoder (CVAE). For example, the conditional latent space decoding model 316 enables inference prediction without an image prompt (IP), but with various conditional attributes, in contrast to conventional IP adapters.

At block 808, a series of images are inferred based on decoding the latent space in response to the received text prompt and the one or more conditions. For example, as shown in FIG. 3, the domain-specific image generation module 310 further includes the image generation module 318 configured to infer a series of images based on decoding the latent space in response to the received text prompt and the one or more received conditions, which are presented on the user device 350. According to various aspects of the present disclosure, the domain-specific image generation module 310 overcomes issues associated with text prompts for image descriptions, which are challenging due to domain-specific terminology and nuances in visual content. Additionally, the domain-specific image generation module 310 overcomes issues of existing methods for text-to-image models, which provide limited control of detailed attributes and do not harmonize with the pre-trained knowledge of diffusion models.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in several ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for a domain-specific attribute-adapter, the method comprising:
learning domain-specific attributes from a collection of domain-specific images;
encoding a latent space of a pre-trained text-to-image diffusion model according to the learned domain-specific attributes from the collection of domain-specific images;
decoding the latent space in response to a received text prompt and one or more conditions; and
inferring a series of images based on decoding the latent space in response to the received text prompt and the one or more conditions.

2. The method of claim 1, in which inferring the series of images comprises controlling, by an image prompt (IP) adapted text-to-image (T2I), generation of the series of images using domain-specific continuous attribute conditions C and on inference prediction from a conditional latent space Z without an image prompt X′.

3. The method of claim 1, in which encoding comprises generating the latent space using a conditional variational autoencoder (CVAE).

4. The method of claim 1, in which encoding comprises separately performing image content embedding of an image prompt from a text embedding of the received text prompt.

5. The method of claim 1, in which inferring further comprises disconnecting an image prompt during the inferring.

6. The method of claim 1, in which decoding comprises modeling and providing domain-specific attribute conditions C using a decoder.

7. The method of claim 1, in which encoding comprises conditioning the latent space of the pre-trained text-to-image diffusion model on particular attributes for a specific domain, in which the learned domain-specific attributes comprise a pose, angle, point-of-view (POV), and/or a size of an in-domain object.

8. The method of claim 1, further comprising displaying, through a user interface, the series of images.

9. A non-transitory computer-readable medium having program code recorded thereon for a domain-specific attribute-adapter, the program code being executed by a processor and comprising:
program code to learn domain-specific attributes from a collection of domain-specific images;
program code to encode a latent space of a pre-trained text-to-image diffusion model according to the learned domain-specific attributes from the collection of domain-specific images;
program code to decode the latent space in response to a received text prompt and one or more conditions; and
program code to infer a series of images based on decoding the latent space in response to the received text prompt and the one or more conditions.

10. The non-transitory computer-readable medium of claim 9, in which the program code to infer the series of images comprises program code to control, by an image prompt (IP) adapted text-to-image (T2I), generation of the series of images using domain-specific continuous attribute conditions C and on inference prediction from a conditional latent space Z without an image prompt X′.

11. The non-transitory computer-readable medium of claim 9, in which the program code to encode comprises program code to generate the latent space using a conditional variational autoencoder (CVAE).

12. The non-transitory computer-readable medium of claim 9, in which the program code to encode comprises program code to separately perform image content embedding of an image prompt from a text embedding of the received text prompt.

13. The non-transitory computer-readable medium of claim 9, in which the program code to infer further comprises program code to disconnect an image prompt during the inferring.

14. The non-transitory computer-readable medium of claim 9, in which the program code to decode comprises program code to model and providing domain-specific attribute conditions C using a decoder.

15. The non-transitory computer-readable medium of claim 9, in which the program code to encode comprises program code to condition the latent space of the pre-trained text-to-image diffusion model on the learned domain-specific attributes, in which the learned domain-specific attributes comprise a pose, angle, point-of-view (POV), and/or a size of an in-domain object.

16. The non-transitory computer-readable medium of claim 9, further comprising program code to display, through a user interface, the series of images.

17. A system for a domain-specific attribute-adapter, the system comprising:
a domain-specific attributes learning model to learn domain-specific attributes from a collection of domain-specific images;
a latent space encoding model to encode a latent space of a pre-trained text-to-image diffusion model according to the learned domain-specific attributes from the collection of domain-specific images;
a conditional latent space decoding model to decode the latent space in response to a received text prompt and one or more conditions; and
an image generation model infer a series of images based on decoding the latent space in response to the received text prompt and the one or more conditions.

18. The system of claim 16, in which the image generation model comprises an image prompt (IP) adapted text-to-image (T2I) to control generation of the series of images using domain-specific continuous attribute conditions C and on inference prediction from a conditional latent space Z without an image prompt X′.

19. The system of claim 17, in which the latent space encoding model further comprises a conditional variational autoencoder (CVAE) to generate the latent space.

20. The system of claim 17, further comprising a user interface to display the series of images.
